(19) United States
(12) Patent Application Publication
(10) Pub. No.: US 2026/0066348 A1
(43) Pub. Date: Mar. 5, 2026

(54) NON-AQUEOUS ELECTROLYTE AND LITHIUM SECONDARY BATTERY

(71) Applicant: Ningde Amperex Technology Limited, Ningde (CN)

(72) Inventors: Junhua JIAN, Ningde (CN); Lilan ZHANG, Ningde (CN); Jianyu LIU, Ningde (CN); Chao TANG, Ningde (CN)

(73) Assignee: Ningde Amperex Technology Limited, Ningde (CN)

(21) Appl. No.: 19/314,715

(22) Filed: Aug. 29, 2025

(30) Foreign Application Priority Data
Aug. 30, 2024 (CN) 202411214915.2

(51) Int. Cl. H01M 10/0567; H01M 10/0525; H01M 10/0569

(52) U.S. Cl. CPC H01M 10/0567; H01M 10/0525; H01M 10/0569; H01M 2300/0034; H01M 2300/0037

(57) ABSTRACT

A non-aqueous electrolyte includes vinylene carbonate and Formula I compound, where based on a total mass of the non-aqueous electrolyte, a mass percentage of vinylene carbonate is A %, where 0.01≤A≤3; a mass percentage of a compound of Formula I is B %; and P=B/A, where 0.5≤P≤50.

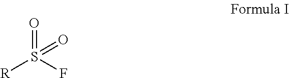

### CROSS REFERENCE TO THE RELATED APPLICATIONS

This application claims the benefit of priority from the Chinese Patent Application No. 202411214915.2, filed on Aug. 30, 2024, the entire content of which is incorporated herein by reference.

### TECHNICAL FIELD

This application relates to the field of energy storage technology, and in particular, to a non-aqueous electrolyte and a lithium secondary battery.

### BACKGROUND

With the continuous development of secondary batteries, higher performance requirements have been imposed. In the prior art, improving low-temperature discharge performance of secondary batteries often leads to a decline in cycling performance. Therefore, the challenge of improving the low-temperature discharge performance of secondary batteries while maintaining cycling performance has received widespread attention.

### SUMMARY

Embodiments of this application provide a non-aqueous electrolyte and a lithium secondary battery, which can achieve good low-temperature discharge performance while improving cycling performance.

According to a first aspect, an embodiment of this application provides a non-aqueous electrolyte, where the non-aqueous electrolyte includes vinylene carbonate and Formula I compound:

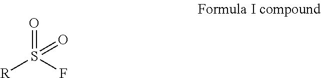

where R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, where the substituent Ra of each group is independently selected from fluorine or a C₁ to C₆ fluoroalkyl group; based on a total mass of the non-aqueous electrolyte, a mass percentage of vinylene carbonate is A %, where 0.01≤A≤3; and a mass percentage of Formula I compound is B %; and P=B/A, and 0.5≤P≤50.

The inventors of the non-aqueous electrolyte according to embodiments of this application have found that when the non-aqueous electrolyte further includes a Formula I compound, and the mass percentage A of vinylene carbonate and the ratio P of the mass percentage B of Formula I compound to A are controlled to be within the above ranges, a robust SEI/CEI layer that improves ion conduction can be synergistically formed. Vinylene carbonate can form a dense SEI/CEI film layer at an electrode interface during battery formation, thereby significantly improving the cycling performance of the secondary battery. However, due to the denseness of the film layer, ion transmission is hindered to some extent, leading to an increase in an initial impedance of the secondary battery, particularly at a low temperature, resulting in reduced discharge capacity. Formula I compound can form a lithium-containing inorganic compound rich in the S and F elements at the electrode interface, introducing more grain boundaries for ion conduction, thus modifying the SEI/CEI film formed by vinylene carbonate. This maintains the denseness of the passivation film while improving ion conduction. Therefore, the low-temperature discharge performance of the lithium secondary battery can be improved while cycling performance is improved.

In some embodiments, for the mass percentage A % of vinylene carbonate in the non-aqueous electrolyte, the mass percentage B % of Formula I compound, and the ratio P, at least one of the following conditions is satisfied: (1) 0.1≤A≤2; (2) 0.5≤B≤5; or (3) 1≤P≤5. Based on the above embodiments, by adjusting the value of the mass percentage A % of vinylene carbonate, the value of the mass percentage B % of Formula I compound, and the ratio thereof to satisfy any of the above conditions, vinylene carbonate in the non-aqueous electrolyte can better cooperate with Formula I compound, thereby further enhancing the low-temperature discharge performance of the lithium secondary battery while improving cycling performance.

In some embodiments, Formula I compound is at least one selected from the following compounds:

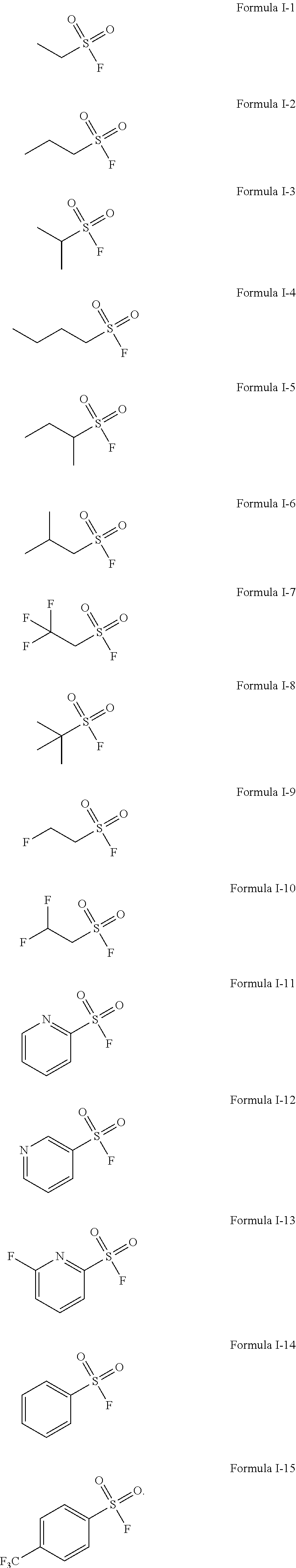

Based on the above embodiments, by selecting the above Formula I compounds, the low-temperature discharge performance of the lithium secondary battery can be further enhanced while cycling performance is improved.

In some embodiments, the non-aqueous electrolyte further includes a cyclic carbonate, the cyclic carbonate is any two selected from ethylene carbonate, propylene carbonate, or fluoroethylene carbonate; and based on the total mass of the non-aqueous electrolyte, a mass percentage of the cyclic carbonate is M %, where 5≤M≤30. Based on the above embodiments, by further adding the cyclic carbonate in the specified amount to the non-aqueous electrolyte of this application and controlling the mass percentage of the cyclic carbonate to be within the specific range, the low-temperature discharge performance of the lithium secondary battery can be further enhanced while cycling performance is improved.

In some embodiments, for the mass percentage M % of the cyclic carbonate in the non-aqueous electrolyte and the mass percentage B % of Formula I compound, 10≤M≤20; and/or 0.1≤B/M≤3. Based on the above embodiments, by controlling the M value of the mass percentage of the cyclic carbonate and the ratio of the mass percentage B % of Formula I compound to the mass percentage M % of the cyclic carbonate in the non-aqueous electrolyte to be within the above ranges, the low-temperature discharge performance of the lithium secondary battery can be further improved while cycling performance is improved.

In some embodiments, the non-aqueous electrolyte further includes a linear ester, where the linear ester includes a fluorinated linear ester and a non-fluorinated linear ester; the linear ester satisfies at least one of the following conditions: (1) the fluorinated linear ester is at least one selected from methyl difluoroethyl carbonate, methyl trifluoroethyl carbonate, ethyl trifluoroethyl carbonate, methyl hexafluoroisopropyl carbonate, di(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate; (2) the non-fluorinated linear ester is at least one selected from dimethyl carbonate, methyl ethyl carbonate, methyl propyl carbonate, ethyl propyl carbonate, methyl acetate, ethyl acetate, propyl acetate, methyl propionate, ethyl propionate, or propyl propionate; or (3) based on the total mass of the non-aqueous electrolyte, a mass percentage of the linear ester is No %, where 10≤N₀≤70. Based on the above embodiments, by further adding a certain amount of linear ester to the non-aqueous electrolyte of this application and controlling the total mass percentage of the linear ester to be within the specific range, the low-temperature discharge performance of the lithium secondary battery can be further enhanced while cycling performance is improved.

In some embodiments, based on the total mass of the non-aqueous electrolyte, for the mass percentage N₁% of the fluorinated linear ester, the mass percentage N₂% of the non-fluorinated linear ester, and the mass percentage No % of the linear ester, at least one of the following conditions is satisfied: (1) 5≤N₁≤50; (2) 5≤N₂≤50; or (3) 20≤N₀≤60. Based on the above embodiments, by controlling the mass percentages of the fluorinated linear ester and the non-fluorinated linear ester and a total of the mass percentages to be within the above ranges, the low-temperature discharge performance of the lithium secondary battery can be further enhanced while cycling performance is improved.

In some embodiments, the non-aqueous electrolyte further includes a polycyano compound, where the polycyano compound is at least one selected from succinonitrile, glutaronitrile, methyl glutaronitrile, adiponitrile, pimelonitrile, suberonitrile, fumaronitrile, or 1,2-bis(cyanoethoxy) ethane; based on the total mass of the non-aqueous electrolyte, a mass percentage of the polycyano compound is X %, where 0.1≤X≤10. Based on the above embodiments, by further adding a certain amount of polycyano compound to the non-aqueous electrolyte of this application and controlling the mass percentage X % of the polycyano compound to be within the above range, a transition metal complex layer can be synchronously formed on the surface of the positive electrode active material during CEI formation by vinylene carbonate, reducing complete oxidative decomposition of the passivation film formed by vinylene carbonate on the surface of the positive electrode material, suppressing gas generation due to oxidation, improving high-temperature storage, while also improving low-temperature discharge performance and cycling performance.

In some embodiments, for the mass percentage X % of the polycyano compound, 0.5≤X≤5. Based on the above embodiments, by controlling the mass percentage X % of the polycyano compound in the non-aqueous electrolyte to be within the above range, high-temperature storage can be further improved while low-temperature discharge performance and cycling performance are improved.

In some embodiments, the non-aqueous electrolyte further includes Formula II compound and/or Formula III compound:

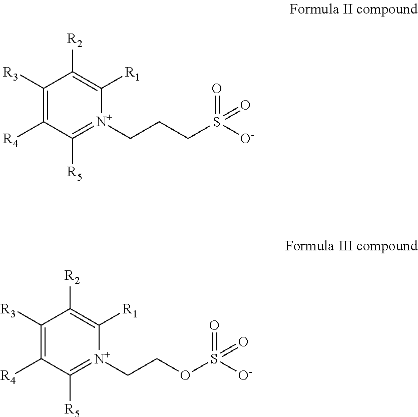

where R₁ to R₅ are independently selected from a hydrogen atom, a fluorine atom, a vinyl group, an ethynyl group, or an anhydride group; based on the total mass of the non-aqueous electrolyte, a mass percentage of Formula II compound is Y₁%, a mass percentage of Formula III compound is Y₂%, and Y %=Y₁%+Y₂%, where 0.1≤Y≤0.5; and any two adjacent groups among R₁ to R₅ either exist independently or are connected via a covalent bond, forming a ring with a parent ring. Based on the above embodiments, by further adding certain amounts of Formula II compound and Formula III compound to the non-aqueous electrolyte of this application and controlling the sum of the mass percentage Y₁% of the Formula II compound and the mass percentage Y₂% of the Formula III compound to be within the above range, enrichment at the interface can be achieved. Due to the presence of nitrogen-containing heterocycles, frontier orbital energy levels are narrow, with a low oxidation potential and high reduction potential. During the initial formation, a molecular skeleton rich in nitrogen-containing heterocycles can be formed, reducing excessive reactions and consumption of vinylene carbonate and Formula I molecules, thereby further improving high-temperature storage while also improving low-temperature discharge performance and cycling performance.

In some embodiments, 0.05≤Y₁≤0.5, for example, 0.05, 0.1, 0.2, 0.3, 0.4, 0.5, or a value within a range defined by any two of these values.

In some embodiments, 0.05≤Y₂≤0.5, for example, 0.05, 0.1, 0.2, 0.3, 0.4, 0.5, or a value within a range defined by any two of these values.

In some embodiments, Formula II compound is at least one selected from the following compounds:

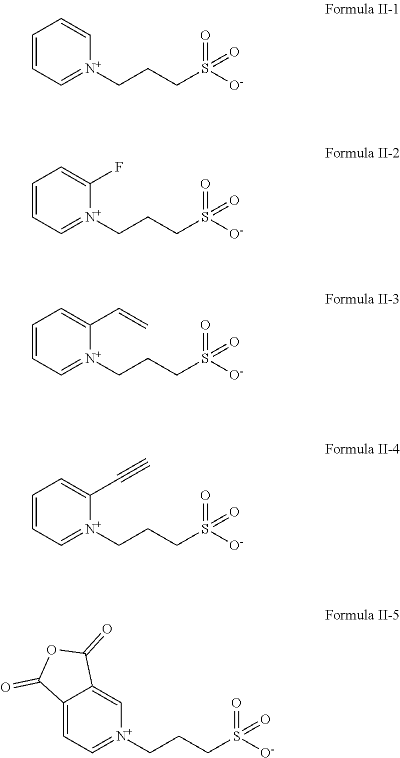 [SMILES: O=S(=O)([O-])CCC[n+]1ccccc1 ; O=S(=O)([O-])CCC[n+]1ccccc1F ; C=Cc1cccc[n+]1CCCS(=O)(=O)[O-] ; C#Cc1cccc[n+]1CCCS(=O)(=O)[O-] ; O=C1OC(=O)c2c[n+](CCCS(=O)(=O)[O-])ccc21]

In some embodiments, Formula III compound is at least one selected from the following compounds:

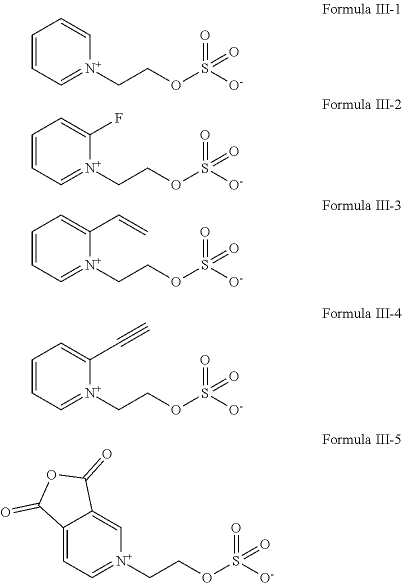

Based on the above embodiments, by selecting the above Formula II compound and/or Formula III compound, high-temperature storage can be further improved while low-temperature discharge performance and cycling performance are improved.

According to a second aspect, an embodiment of this application provides a lithium secondary battery, including a positive electrode, where the positive electrode includes a positive electrode current collector and a positive electrode active layer disposed on at least one surface of the positive electrode current collector; a negative electrode, where the negative electrode includes a negative electrode current collector and a negative electrode active layer disposed on at least one surface of the negative electrode current collector; a separator; and a non-aqueous electrolyte, where the non-aqueous electrolyte is the non-aqueous electrolyte described above.

### DETAILED DESCRIPTION

To make the objectives, technical solutions, and advantages of this application clearer, this application is further described in detail below with reference to some embodiments. It should be understood that the specific embodiments described herein are merely used to explain this application but are not intended to limit this application.

Embodiments of this application provide a lithium secondary battery, including a non-aqueous electrolyte, a positive electrode, a negative electrode, and a separator.

### Non-Aqueous Electrolyte

The non-aqueous electrolyte used in the lithium secondary battery of these embodiments of this application includes an electrolytic salt and a solvent dissolving the electrolytic salt. In some embodiments, the non-aqueous electrolyte includes vinylene carbonate and a Formula I compound:

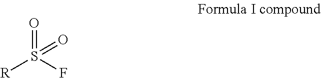

where R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, where the substituent Ra of each group is independently selected from fluorine or a C₁ to C₆ fluoroalkyl group.

In some embodiments, based on a total mass of the non-aqueous electrolyte, a mass percentage of vinylene carbonate is A %, where 0.01≤A≤3, preferably 0.1≤A≤2. For example, A is 0.01, 0.1, 1, 1.5, 2, 2.5, 3, or a value within a range defined by any two of these values. A mass percentage of Formula I compound is B %, where 0.5≤B≤5. For example, B is 0.5, 0.8, 1.0, 2.2, 3.8, 4.5, 5, or a value within a range defined by any two of these values. A ratio of the mass percentage B % of Formula I compound to the mass percentage A % of vinylene carbonate is P=B/A, where 0.5≤P≤50, preferably 1≤P≤5. For example, P is 0.5, 2.0, 6.9, 10.1, 22.5, 39.3, 50, or a value within the range defined by any two of these values. By adding vinylene carbonate and Formula I compound to the non-aqueous electrolyte and controlling the mass percentage A % of vinylene carbonate, the mass percentage B % of Formula I compound, and the ratio P to be within the above ranges, low-temperature discharge performance can be improved while cycling performance is improved.

In some embodiments, Formula I compound is at least one selected from the following compounds:

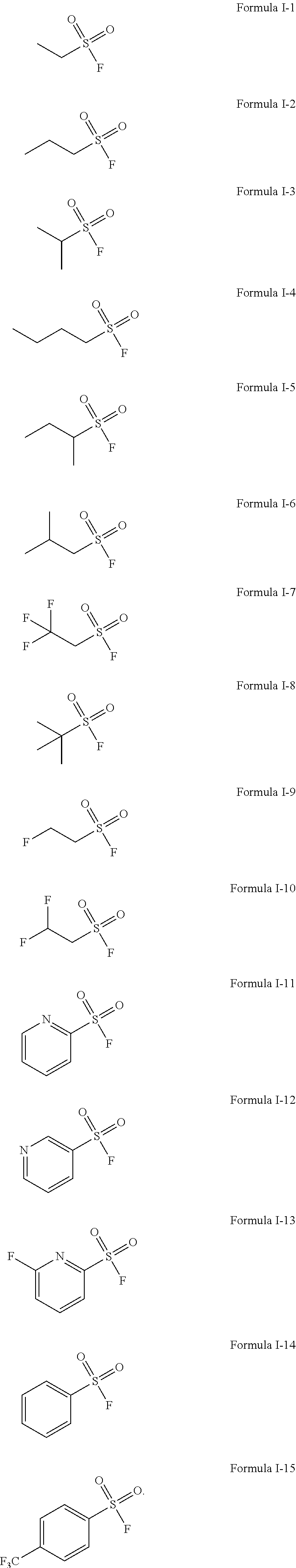

By adding the Formula I compound of the forgoing type to the non-aqueous electrolyte, the low-temperature discharge performance of the lithium secondary battery can be further enhanced while cycling performance is improved.

In some embodiments, the non-aqueous electrolyte further includes a cyclic carbonate, where the cyclic carbonate is any two selected from ethylene carbonate, propylene carbonate, or fluoroethylene carbonate; and based on the total mass of the non-aqueous electrolyte, a mass percentage of the cyclic carbonate is M %, where 5≤M≤30. In some embodiments, 10≤M≤20. For example, M is 5, 6.5, 7.6, 15.0, 19.5, 23.8, 30, or a value within a range defined by any two of these values. By further adding a certain amount of cyclic carbonate to the non-aqueous electrolyte and controlling the mass percentage of the cyclic carbonate to be within the above specific range, the low-temperature discharge performance of the lithium secondary battery can be further enhanced while cycling performance is improved.

In some embodiments, for the ratio of the mass percentage B % of Formula I compound to the mass percentage M % of the cyclic carbonate in the non-aqueous electrolyte, 0.1≤B/M≤3. In some embodiments, 0.1≤B/M≤2. In some embodiments, 1≤B/M≤3. In some embodiments, 0.3≤B/M≤1. In some embodiments, 2≤B/M≤3. In some embodiments, 1.5≤B/M≤3. By controlling the ratio of the mass percentage B % of Formula I compound to the mass percentage M % of the cyclic carbonate to be within the above ranges, the low-temperature discharge performance of the lithium secondary battery can be further enhanced while cycling performance is improved.

In some embodiments, the non-aqueous electrolyte further includes a linear ester, where the linear ester includes a fluorinated linear ester and a non-fluorinated linear ester.

In some embodiments, the fluorinated linear ester is selected from at least one of methyl difluoroethyl carbonate, methyl trifluoroethyl carbonate, ethyl trifluoroethyl carbonate, methyl hexafluoroisopropyl carbonate, di(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate.

In some embodiments, the non-fluorinated linear ester is at least one selected from dimethyl carbonate, methyl ethyl carbonate, methyl propyl carbonate, ethyl propyl carbonate, methyl acetate, ethyl acetate, propyl acetate, methyl propionate, ethyl propionate, or propyl propionate.

In some embodiments, based on the total mass of the non-aqueous electrolyte, a mass percentage of the linear ester is No %, where 10≤N₀≤70. For example, N₀ is 10, 20, 30, 40, 50, 60, 70, or a value within a range defined by any two of these values. By further adding a certain amount of linear ester to the non-aqueous electrolyte and controlling the mass percentage of the linear ester to be within the specific range, the low-temperature discharge performance of the lithium secondary battery can be further enhanced while cycling performance is improved.

In some embodiments, based on the total mass of the non-aqueous electrolyte, for the mass percentage N₁% of the fluorinated linear ester, 5≤N₁≤50. For example, N₁ is 5, 10, 15, 20, 30, 40, 50, or a value within a range defined by any two of these values.

In some embodiments, based on the total mass of the non-aqueous electrolyte, for a mass percentage N₂% of the non-fluorinated linear ester, 5≤N₂≤50. For example, N₂ is 5, 10, 15, 20, 30, 40, 50, or a value within a range defined by any two of these values. By controlling the mass percentages of the fluorinated linear ester and the non-fluorinated linear ester to be within the above ranges, the low-temperature discharge performance of the lithium secondary battery can be further enhanced while cycling performance is improved.

In some embodiments, the non-aqueous electrolyte further includes a polycyano compound, where the polycyano compound is at least one selected from succinonitrile, glutaronitrile, methyl glutaronitrile, adiponitrile, pimelonitrile, suberonitrile, fumaronitrile, or 1,2-bis(cyanoethoxy) ethane; and based on the total mass of the non-aqueous electrolyte, a mass percentage of the polycyano compound is X %, where 0.1≤X≤10. For example, X is 0.1, 0.5, 1.5, 2, 5, 7, 10, or a value within a range defined by any two of these values. By further adding a polycyano compound to the non-aqueous electrolyte and controlling the mass percentage X % of the polycyano compound to be within the above range, high-temperature storage can be improved while low-temperature discharge performance and cycling performance are improved.

In some embodiments, the non-aqueous electrolyte includes Formula II compound and/or Formula III compound:

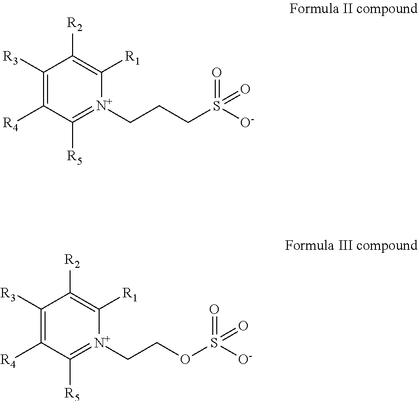

where R₁ to R₅ are independently selected from a hydrogen atom, a fluorine atom, a vinyl group, an ethynyl group, or an anhydride group; and based on the total mass of the non-aqueous electrolyte, a mass percentage of Formula II compound is Y₁%, and a mass percentage of Formula III compound is Y₂%, and Y %=Y₁%+Y₂%, where 0.1≤Y≤0.5. For example, 0.1, 0.2, 0.3, 0.4, 0.5, or a value within a range defined by any two of these values. Any two adjacent groups among R₁ to R₅ either exist independently or are connected via a covalent bond, forming a ring with a parent ring. By further adding a certain amount of Formula II compound and Formula III compound to the non-aqueous electrolyte and controlling the sum of the mass percentage Y₁% of Formula II compound and the mass percentage Y₂% of Formula III compound to be within the above ranges, high-temperature storage can be further improved while low-temperature discharge performance and cycling performance are improved.

In some embodiments, Formula II compound is at least one selected from the following compounds:

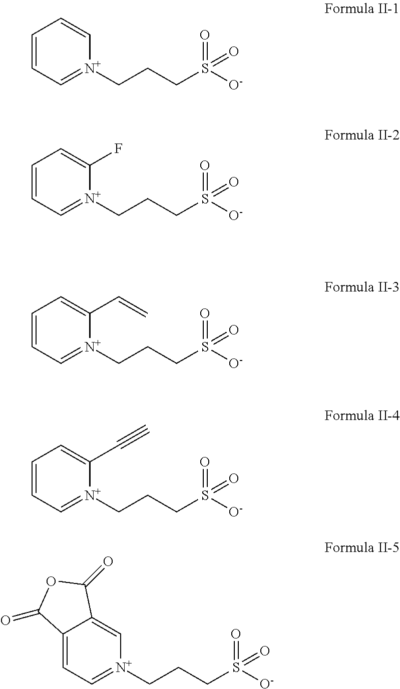 [SMILES: O=S(=O)([O-])CCC[n+]1ccccc1 ; O=S(=O)([O-])CCC[n+]1ccccc1F ; C=Cc1cccc[n+]1CCCS(=O)(=O)[O-] ; C#Cc1cccc[n+]1CCCS(=O)(=O)[O-] ; O=C1OC(=O)c2c[n+](CCCS(=O)(=O)[O-])ccc21]

In some embodiments, Formula III compound is at least one selected from the following compounds:

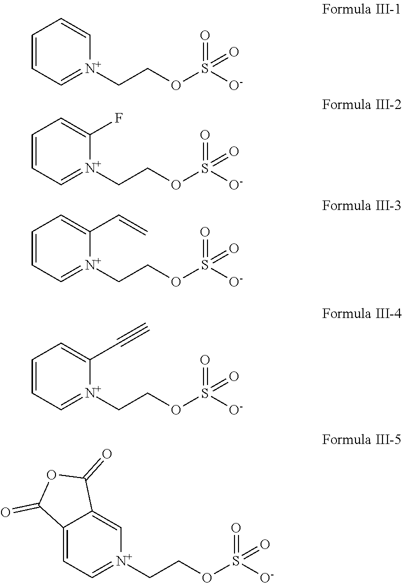

By selecting Formula II compound and/or Formula III compound of the above types, high-temperature storage can be further improved while low-temperature discharge performance and cycling performance are improved.

The non-aqueous electrolyte may further include a lithium salt and a non-aqueous solvent. A type of lithium salt is not particularly limited in this application as long as the objectives of this application can be achieved. For example, the lithium salt may include, but is not limited to, at least one of lithium hexafluorophosphate, lithium tetrafluoroborate, lithium difluorophosphate, lithium bis(trifluoromethanesulfonyl)imide, lithium bis(fluorosulfonyl)imide, lithium bis(oxalate) borate, or lithium difluoro (oxalate) borate. Based on the mass of the non-aqueous electrolyte, a mass percentage of the lithium salt may be 8% to 15%, for example, the mass percentage of the lithium salt may be 8%, 9%, 10%, 11%, 12.5%, 13%, 15%, or in a range defined by any two of these values. For example, a type of the non-aqueous solvent may include, but is not limited to, at least one of an ether compound or another organic solvent.

The ether compound may include, but is not limited to, at least one of ethylene glycol dimethyl ether, dibutyl ether, tetraethylene glycol dimethyl ether, diethylene glycol dimethyl ether, 1,2-dimethoxyethane, 1,2-diethoxyethane, 1-ethoxy-1-methoxyethane, 2-methyltetrahydrofuran, or tetrahydrofuran.

The another organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate.

### Positive Electrode

The positive electrode includes a positive electrode current collector and a positive electrode active layer disposed on a surface of the positive electrode current collector.

The positive electrode active layer contains a positive electrode active material, and the positive electrode active layer may be one or more layers. Layers of the multilayer positive electrode active material may contain the same or different positive electrode active materials. The positive electrode active material is any substance capable of reversibly intercalating and deintercalating alkali metal ions.

The positive electrode active material includes a lithium transition metal oxide containing nickel and another transition metal. In the lithium transition metal oxide containing nickel and another transition metal, based on a total molar amount of the transition metal, nickel may account for 60 mol % or more, for example, 75 mol % or more, for example, 80 mol % or more, for example, 85 mol % or more, or for example, 90 mol % or more.

In some embodiments, the positive electrode active material includes at least one active material selected from a group formed by Li—Ni—Co—Al (NCA), Li—Ni—Co—Mn (NCM), lithium cobalt oxide (LiCoO₂), lithium manganese oxide (LiMnO₂), lithium nickel oxide (LiNiO₂), or lithium iron phosphate (LiFePO₄).

In some embodiments, the positive electrode active layer includes a positive electrode conductive material; and a type of the positive electrode conductive material is not limited, and may be any known conductive material. Examples of the positive electrode conductive material may include, but are not limited to, carbon black such as acetylene black and Super P; amorphous carbon such as needle coke; carbon nanotubes; graphene; and the like. The positive electrode conductive material may be used alone or in any combination.

In some embodiments, the positive electrode material layer includes a positive electrode binder. A type of the positive electrode binder is not particularly limited, and in the case of using a coating method, any material that can be dissolved or dispersed in a liquid medium used during electrode manufacturing may be used. Examples of the positive electrode binder may include, but are not limited to, one or more of the following: resin-based polymer such as polyethylene, polypropylene, polyethylene terephthalate, polymethyl methacrylate, polyimide, aromatic polyamide, cellulose, or nitrocellulose, rubber-like polymer such as styrene-butadiene rubber (SBR), nitrile rubber (NBR), fluororubber, isoprene rubber, polybutadiene rubber, or ethylene-propylene rubber, thermoplastic elastomer-like polymer such as styrene-butadiene-styrene block copolymer or hydride thereof, ethylene propylene diene terpolymer (EPDM), styrene-ethylene-butadiene-ethylene copolymer, styrene-isoprene-styrene block copolymer or hydride thereof, soft resin-like polymer such as syndiotactic-1,2-polybutadiene, polyvinyl acetate, ethylene-vinyl acetate copolymer, or propylene-α-olefin copolymer, fluorine-based polymer such as polyvinylidene fluoride (PVDF), polytetrafluoroethylene, fluorinated polyvinylidene fluoride, or polytetrafluoroethylene-ethylene copolymer, polymer composition with ion conductivity for alkali metal ions, and the like. The above positive electrode binders may be used alone or in any combination.

A type of the solvent used for forming a positive electrode slurry is not limited, as long as the solvent is capable of dissolving or dispersing the positive electrode active material, the conductive material, a positive electrode binder, and a required thickener. Examples of the solvent used for forming the positive electrode slurry may include any one of an aqueous solvent or an organic solvent. Examples of the aqueous medium may include, but are not limited to, a mixed medium of alcohol and water, water, or the like. Examples of organic medium may include, but are not limited to, aliphatic hydrocarbon such as hexane; aromatic hydrocarbons such as benzene, toluene, xylene, and methylnaphthalene; heterocyclic compound such as quinoline and pyridine; ketone such as acetone, methyl ethyl ketone, and cyclohexanone; ester such as methyl acetate and methyl acrylate; amine such as diethylenetriamine and N,N-dimethylaminopropylamine; ether such as diethyl ether, propylene oxide, and tetrahydrofuran; amide such as N-methylpyrrolidone, dimethylformamide, and dimethylacetamide; and aprotic polar solvent such as hexamethylphosphoramide or dimethyl sulfoxide.

The thickener is typically used to adjust a viscosity of a slurry. In the case of using an aqueous medium, a thickener and a styrene-butadiene rubber emulsion may be used for slurry formation. A type of the thickener is not particularly limited, and examples may include, but are not limited to, carboxymethyl cellulose, methyl cellulose, hydroxymethyl cellulose, ethyl cellulose, polyvinyl alcohol, oxidized starch, phosphorylated starch, casein, a salt thereof, and the like. The foregoing thickeners may be used alone or in any combination.

The positive electrode current collector is not limited to a particular type, and may be any known material suitable for serving as a positive electrode current collector. Examples of the positive electrode current collector may include, but are not limited to, metal materials such as aluminum, stainless steel, nickel plating, titanium, or tantalum; and materials such as carbon cloth and carbon paper. In some embodiments, the positive electrode current collector is a metal material. In some embodiments, the positive electrode current collector is aluminum.

To reduce an electronic contact resistance between the positive electrode current collector and the positive electrode active layer, a surface of the positive electrode current collector may include a conductive additive or a conductive coating. Examples of the conductive additive may include, but are not limited to, noble metals such as carbon, gold, platinum, silver, or the like. Examples of the conductive coating may include a mixed layer containing an inorganic oxide, a conductive agent, a binder, and the like.

### Negative Electrode

The negative electrode includes a negative electrode current collector and a negative electrode active layer disposed on at least one surface of the negative electrode current collector, where the negative electrode active layer contains a negative electrode active material. In some embodiments, a rechargeable capacity of the negative electrode active material is greater than a discharge capacity of the positive electrode active material to prevent unintended precipitation of lithium metal on the negative electrode during charge.

The negative electrode active material may include at least one of natural graphite, artificial graphite, mesocarbon microbeads (MCMB), silicon, silicon-carbon composite, SiOₓ (0.5<x<1.6), Li—Sn alloy, Li—Sn—O alloy, Sn, SnO, SnO₂, spinel-structure lithium titanate Li₄Ti₅O₁₂, Li—Al alloy, metallic lithium, or the like. Optionally, the negative electrode active material may further include an amorphous carbon material, where the amorphous carbon may be soft carbon (low-temperature calcined carbon), hard carbon, mesophase pitch carbide, calcined coke, or the like.

The negative electrode material layer of this application further includes a negative electrode binder. The negative electrode binder may enhance binding between particles of the negative electrode active material and binding between the negative electrode active material and the current collector. A type of the negative electrode binder is not particularly limited, as long as a material is stable to an electrolyte or a solvent used in manufacturing of the electrode. In some embodiments, the negative electrode binder includes a resin binder. Examples of the resin binder include, but are not limited to, fluororesin, polyacrylonitrile (PAN), polyimide resin, acrylic resin, polyolefin resin, and the like. When an aqueous solvent is used to prepare the negative electrode slurry, the negative electrode binder includes, but is not limited to, carboxymethyl cellulose (CMC) or a salt thereof, styrene-butadiene rubber (SBR), polyacrylic acid (PAA) or a salt thereof, polyvinyl alcohol, and the like.

The negative electrode material layer of this application further includes a conductive agent. A type of the negative electrode conductive agent is not particularly limited in this application, as long as the objectives of this application can be achieved. For example, the negative electrode conductive agent may be at least one of acetylene black, Ketjen black, carbon nanotubes, carbon fibers, carbon dots, graphene, or the like, where the carbon nanotubes may include, but are not limited to, at least one of single-walled carbon nanotubes or multi-walled carbon nanotubes.

The negative electrode current collector is not particularly limited in this application, as long as the objectives of this application can be achieved. For example, the negative electrode current collector may include copper foil, aluminum foil, nickel foil, stainless steel foil, titanium foil, nickel foam, copper foam, a polymer matrix coated with a conductive metal, or the like. The conductive metal includes, but is not limited to, copper, nickel, or titanium, and a material of the polymer matrix includes, but is not limited to, at least one of polyethylene, polypropylene, ethylene-propylene copolymer, polyethylene terephthalate, polyethylene naphthalate, or poly(p-phenylene terephthalamide). In this application, thicknesses of the negative electrode current collector and the negative electrode active layer are not particularly limited, as long as the objectives of this application can be achieved. For example, the thickness of the negative electrode current collector is 4 μm to 12 μm, and the thickness of a negative electrode active layer on one side is 30 μm to 160 μm. In this application, the negative electrode active layer may be disposed on one surface in a thickness direction of the negative electrode current collector or on both surfaces in the thickness direction of the negative electrode current collector. It should be noted that the “surface” herein may be the entire area of the negative electrode current collector or a partial area of the negative electrode current collector. This is not particularly limited in this application as long as the objectives of this application can be achieved.

A compacted density of the negative electrode plate is not particularly limited in this application, as long as the objectives of this application can be achieved. For example, the compacted density of the negative electrode plate may be 1.0 g/cm³ to 1.85 g/cm³. A cold-pressing pressure of the negative electrode plate is not particularly limited in this application, as long as the objectives of this application can be achieved. For example, the cold-pressing pressure of the negative electrode plate may be 3 tons to 30 tons.

Optionally, the negative electrode plate may further include a conductive layer, where the conductive layer is between the negative electrode current collector and the negative electrode material layer. The conductive layer in this application is not limited to a particular composition, and may be a conductive layer commonly used in the art. The conductive layer includes a conductive agent and a binder. The conductive agent and the binder in the conductive layer are not particularly limited in this application, and may be at least one of the conductive agents and binders described above. A mass ratio of the conductive agent to the binder in the conductive layer is not particularly limited in this application, and persons skilled in the art may make selections according to actual needs, as long as the objectives of this application can be achieved. A thickness of the conductive layer is not particularly limited in this application, as long as the objectives of this application can be achieved, for example, the thickness of the conductive layer is 1 μm to 10 μm.

### Separator

Typically, a separator is provided between the positive electrode and the negative electrode in this application. The separator is used to separate the positive electrode plate and the negative electrode plate, preventing internal short circuits in the secondary battery, allowing electrolyte ions to pass freely without affecting the electrochemical charge/discharge.

The separator is not particularly limited in this application, as long as the objectives of this application can be achieved. For example, a material of the separator may include, but is not limited to, at least one of polyolefin (PO) mainly including polyethylene (PE) or polypropylene (PP), polyester (for example, polyethylene terephthalate (PET) film), cellulose, polyimide (PI), polyamide (PA), spandex, or aramid. A type of the separator may include at least one of a woven film, a non-woven film, a microporous film, a composite film, a calendered film, or a spun film.

In this application, the separator may include a substrate and a surface treatment layer. The substrate may be a non-woven fabric or a composite film with a porous structure, and a material of the substrate may include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film may be used. Optionally, a surface treatment layer is disposed on at least one surface of the substrate, where the surface treatment layer may be a polymer layer or an inorganic layer, or a layer formed by mixing a polymer and an inorganic material. For example, the inorganic layer includes inorganic particles and a binder. The inorganic particles are not particularly limited in this application, and for example, may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide, or barium sulfate. The binder is not particularly limited in this application, and for example, may include at least one of the binders described above. The polymer layer includes a polymer, and a material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

In this application, a pore size of the separator is 0.01 μm to 1 μm, and a thickness is 5 μm to 50 μm. In some embodiments, the thickness of the separator is greater than 1 μm, greater than 5 μm, or greater than 8 μm. In some embodiments, the thickness of the separator is less than 50 μm, less than 40 μm, or less than 30 μm. When the thickness of the separator is within the above range, insulation and mechanical strength can be ensured, and the rate performance and energy density of the secondary battery can be ensured.

The electrochemical apparatus of this application further includes a packaging bag for accommodating the positive electrode plate, the separator, the negative electrode plate, and the electrolyte, as well as other components in the electrochemical apparatus known in the art. The other components described above are not limited in this application. The packaging bag is not particularly limited in this application, and may be a packaging bag known in the art, as long as the objectives of this application can be achieved.

### EXAMPLES

In the following descriptions, a lithium-ion battery is used as an example. Examples and comparative examples are provided to more specifically describe the embodiments of the secondary battery of this application. Persons skilled in the art can understand that the preparation methods described in this application are merely examples, and any other suitable preparation methods are within the scope of this application. Various tests and evaluations are conducted according to the methods described below. In addition, unless otherwise specified, “part” and “%” are based on weight.

### Example 1-1

### <Preparation of Lithium-Ion Battery>

(1) Preparation of positive electrode: A positive electrode active material lithium cobalt oxide, a conductive agent conductive carbon black, and polyvinylidene fluoride (PVDF) were mixed in a mass ratio of 95:2:3, N-methylpyrrolidone (NMP) was added, and a mixture was stirred uniformly under the action of a vacuum mixer to obtain a positive electrode slurry with a solid content of 70 wt %. The positive electrode slurry was uniformly applied on one surface of a positive electrode current collector aluminum foil that was 9 μm thick, and dried to obtain a positive electrode plate with one side applied with the positive electrode mixture layer. The above steps were repeated on another surface of the positive electrode current collector aluminum foil to obtain a positive electrode plate with two sides applied with the positive electrode mixture layer. After cold pressing, cutting, slitting, and drying, a positive electrode plate with a specification of 74 mm×867 mm was obtained.
(2) Preparation of non-aqueous electrolyte: In a dry argon atmosphere glove box, diethyl carbonate was used as a base solvent, and then vinylene carbonate, Formula I compound, and lithium hexafluorophosphate (LiPF₆) were dissolved in the base solvent to obtain an electrolyte. Based on a total mass of the electrolyte, a mass percentage of LiPF₆ is 12.5%, mass percentages of vinylene carbonate and Formula I compound were as shown in Table 1, and the balance is diethyl carbonate.
(3) Preparation of negative electrode: Artificial graphite was used as a negative electrode active material; the negative electrode active material, styrene-butadiene rubber (SBR), polyacrylic acid (PAA), carbon nanotubes (CNT), and carboxymethyl cellulose (CMC) were mixed in a mass ratio of 95.8:2.4:0.5:0.5:0.8; then deionized water was added as a solvent and stirred uniformly to prepare a negative electrode slurry with a solid content of 45 wt %. The negative electrode slurry was uniformly applied on one surface of a negative electrode current collector copper foil that was 6 μm thick, and dried to obtain a negative electrode plate with one side applied with the negative electrode mixture layer. The above steps were repeated on another surface of the negative electrode current collector copper foil to obtain a negative electrode plate with two sides applied with the negative electrode mixture layer. After cold pressing, cutting, slitting, and drying, a negative electrode plate with a specification of 76.6 mm×875 mm was obtained.
(4) Preparation of separator: A porous polyethylene film that was 15 μm thick was used as the separator.
(5) Preparation of lithium-ion battery: The positive electrode plate, separator, and negative electrode plate were stacked in order, with the separator placed between the positive electrode plate and the negative electrode plate for separation, and wound to obtain a bare cell. The bare cell was placed in a packaging bag; the electrolyte was injected; and the cell was sealed. After processes such as formation, degassing, trimming, and capacity testing, a lithium-ion battery was obtained.

### <Test Methods>

### (1) Low-Temperature Discharge Performance Test

The lithium-ion battery was placed in a high-low temperature chamber, a temperature was adjusted to 25° C., and the battery was left standing for 30 minutes to reach a constant temperature. The lithium-ion battery at constant temperature was discharged at a constant current of 0.5C to 3.0V, then charged at a constant current of 0.5C to 4.5V, and further charged at a constant voltage of 4.5V to 0.05C. At the same temperature of 25° C., the battery was discharged at a constant current of 0.5C to 3.0V, and a discharge capacity was recorded as an initial discharge capacity. At 25° C., the battery was charged at a constant current of 0.5C to 4.5V, and further charged at a constant voltage of 4.5V to 0.05C. Then, the lithium-ion battery was placed at 0° C. and left standing for 30 minutes to ensure that a temperature of the lithium-ion battery was consistent with an ambient temperature. At 0° C., the battery was discharged at a constant current of 0.5C to 3.0V, and a discharge capacity was recorded as a low-temperature discharge capacity, where

$$low - temperature discharge capacity retention rate = ( low - temperature discharge capacity / initial discharge capacity ) \times 100 \% .$$

### (2) Cycling Performance Test:

The lithium-ion battery was placed in a test chamber with a constant temperature of 45° C. and left standing for 30 minutes to reach a constant temperature. The battery was charged at a constant current of 0.5C to 4.5V, charged at a constant voltage to 0.025C, left standing for 5 minutes, and discharged at a constant current of 0.5C to 3.0V, with a discharge capacity recorded as an initial discharge capacity CO. These steps were repeated for 100 cycles, and a discharge capacity at 100th cycle was recorded as C1. A cycle capacity retention rate of the lithium-ion battery was calculated, where

$$cycle capacity retention rate = C 1 / C 0 \times 100 \% .$$

### (3) High-Temperature Storage Performance Test

The lithium-ion battery was placed in a constant temperature environment at 25° C. and left standing for 30 minutes to reach a constant temperature. The battery was charged at a constant current of 0.5C to 4.5V, and further charged at a constant voltage of 4.5V to 0.025C. A thickness of the lithium-ion battery was recorded as an initial thickness. The lithium-ion battery was transferred to a constant temperature chamber at 60° C. for storage for 30 days. The thickness of the lithium-ion battery was tested and recorded every 6 days, and a thickness after 30 days was recorded as a storage thickness. A thickness swelling rate of the lithium-ion battery was calculated and used as an indicator to evaluate the high-temperature storage performance of the lithium-ion battery, where

$$high - temperature storage swelling rate = ( storage thickness - initial thickness ) / initial thickness \times 100 \% .$$

The lithium-ion batteries of the following examples or comparative examples differ from Example 1-1 only in that the value of the mass percentage A of vinylene carbonate, the type of Formula I compound, and the value of the mass percentage B of Formula I compound were adjusted according to Table 1. The performance test results of the lithium-ion batteries of each example and comparative example are shown in Table 1 below.

TABLE 1

| | | | | | Low- | |
|---|---|---|---|---|---|---|
| | | | | | temper- | Cycle |
| | | | | | ature | capac- |
| | | | | | discharge | ity |
| | | | | | capacity | reten- |
| | | | | | retention | tion |
| | Formula I | | | | rate | rate |
| Group | compound | B | A | P | (%) | (%) |
| Example 1-1 | Formula I-1 | 0.5 | 1 | 0.5 | 70 | 69 |
| Example 1-2 | Formula I-1 | 1 | 1 | 1.0 | 75 | 74 |
| Example 1-3 | Formula I-1 | 5 | 1 | 5.0 | 73 | 77 |
| Example 1-4 | Formula I-1 | 10 | 1 | 10.0 | 71 | 70 |
| Example 1-5 | Formula I-1 | 25 | 1 | 25.0 | 71 | 71 |
| Example 1-6 | Formula I-1 | 50 | 1 | 50.0 | 69 | 69 |
| Example 1-7 | Formula I-1 | 0.5 | 0.01 | 50.0 | 69 | 66 |
| Example 1-8 | Formula I-1 | 1 | 0.1 | 10.0 | 72 | 72 |
| Example 1-9 | Formula I-1 | 1 | 0.5 | 2.0 | 73 | 75 |
| Example 1-10 | Formula I-1 | 1 | 2 | 0.5 | 68 | 69 |
| Example 1-11 | Formula I-1 | 2 | 3 | 0.7 | 67 | 68 |
| Example 1-12 | Formula I-1 | 0.5 | 0.5 | 1.0 | 74 | 76 |
| Example 1-13 | Formula I-1 | 2 | 0.5 | 4.0 | 75 | 75 |
| Example 1-14 | Formula I-1 | 5 | 0.5 | 10.0 | 72 | 73 |
| Example 1-15 | Formula I-1 | 10 | 0.5 | 20.0 | 71 | 71 |
| Example 1-16 | Formula I-1 | 15 | 0.5 | 30.0 | 71 | 72 |
| Example 1-17 | Formula I-2 | 1 | 1 | 1.0 | 73 | 76 |
| Example 1-18 | Formula I-3 | 1 | 1 | 1.0 | 74 | 78 |
| Example 1-19 | Formula I-5 | 1 | 1 | 1.0 | 75 | 75 |
| Example 1-20 | Formula I-7 | 1 | 1 | 1.0 | 73 | 77 |
| Example 1-21 | Formula I-9 | 1 | 1 | 1.0 | 74 | 79 |
| Example 1-22 | Formula I-10 | 1 | 1 | 1.0 | 73 | 76 |
| Comparative | Formula I-1 | 10 | / | / | 65 | 60 |
| example 1-1 | | | | | | |
| Comparative | / | / | 1 | 0.0 | 61 | 64 |
| example 1-2 | | | | | | |
| Comparative | Formula I-1 | 0.1 | 1 | 0.1 | 62 | 63 |
| example 1-3 | | | | | | |
| Comparative | Formula I-1 | 55 | 1 | 55.0 | 63 | 65 |
| example 1-4 | | | | | | |
| Comparative | Formula I-1 | 0.1 | 0.005 | 20.0 | 63 | 60 |
| example 1-5 | | | | | | |
| Comparative | Formula I-1 | 2 | 3.5 | 0.6 | 61 | 62 |
| example 1-6 | | | | | | |

In the above table, the mass percentage of each substance is based on the mass of the electrolyte, A is the value of the mass percentage A % of vinylene carbonate, B is the value of the mass percentage B % of Formula I compound, and “/” indicates that the substance is not included.

From Table 1, it can be learned that the non-aqueous electrolyte of the lithium-ion battery prepared in the example of this application includes vinylene carbonate and Formula I compound, where the mass percentage of vinylene carbonate is A %, the mass percentage of Formula I compound is B %, and P=B/A. When 0.01≤A≤3 and 0.5≤P≤50, the low-temperature discharge capacity retention rate of the lithium secondary battery can be improved while the cycle capacity retention rate is improved. In particular, when at least one of 0.1≤A≤2, 0.5≤B≤5, or 1≤P≤5 is satisfied, the low-temperature discharge capacity retention rate of the lithium secondary battery can be further enhanced while the cycle capacity retention rate is improved.

The lithium-ion batteries of the following examples differ from Example 1-3 only in that during the preparation of the electrolyte, specific types and amounts of cyclic carbonate and linear ester were added to the base solvent. The mass percentages thereof in the electrolyte are shown in Table 2. The performance test results of the lithium-ion batteries of the examples are shown in Table 2 below.

TABLE 2

| | | | | | | | | Linear ester | | | | | | |
|---|---|---|---|---|---|---|---|---|---|---|---|---|---|---|
| | | | | | | | | | Fluori- | Non- | Non- | | Low- | |
| | | | | | | | | Fluori- | nated | fluori- | fluorinated | | temperature | |
| | | | | | | | | nated | linear | nated | linear | | discharge | Cycle |
| | Cyclic carbonate | | | | | | | linear | ester | linear | ester | Total | capacity | capacity |
| | | Amount | | Amount | Amount | B | | ester | amount | ester | amount | amount | retention | retention |
| Group | Type | (%) | Type | (%) | M % | % | B/M | type | N₁ % | type | N₂ % | N₀ % | rate (%) | rate (%) |
| Example | / | / | / | / | / | 5 | / | / | / | / | / | / | 73 | 77 |
| 1-3 | | | | | | | | | | | | | | |
| Example | EC | 2.5 | PC | 2.5 | 5 | 5 | 1 | / | / | / | / | / | 73 | 79 |
| 2-1 | | | | | | | | | | | | | | |
| Example | PC | 2.5 | FEC | 2.5 | 5 | 5 | 1 | / | / | / | / | / | 72 | 78 |
| 2-2 | | | | | | | | | | | | | | |
| Example | EC | 2.5 | FEC | 2.5 | 5 | 5 | 1 | / | / | / | / | / | 72 | 79 |
| 2-3 | | | | | | | | | | | | | | |
| Example | EC | 5 | FEC | 5 | 10 | 5 | 0.5 | / | / | / | / | / | 75 | 84 |
| 2-4 | | | | | | | | | | | | | | |
| Example | EC | 10 | FEC | 10. | 20 | 5 | 0.25 | / | / | / | / | / | 76 | 84 |
| 2-5 | | | | | | | | | | | | | | |
| Example | EC | 15 | FEC | 15 | 30 | 5 | 0.17 | / | / | / | / | / | 72 | 79 |
| 2-6 | | | | | | | | | | | | | | |
| Example | EC | 5 | FEC | 5 | 10 | 1 | 0.1 | / | / | / | / | / | 75 | 83 |
| 2-7 | | | | | | | | | | | | | | |
| Example | EC | 5 | FEC | 5 | 10 | 5 | 0.5 | / | / | / | / | / | 76 | 84 |
| 2-8 | | | | | | | | | | | | | | |
| Example | EC | 5 | FEC | 5 | 10 | 10 | 1 | / | / | / | / | / | 74 | 81 |
| 2-9 | | | | | | | | | | | | | | |
| Example | EC | 5 | FEC | 5 | 10 | 30 | 3 | / | / | / | / | / | 74 | 80 |
| 2-10 | | | | | | | | | | | | | | |
| Example | / | / | / | / | / | / | / | Methyl | 20 | / | / | 20 | 75 | 82 |
| 2-11 | | | | | | | | difluoroethyl | | | | | | |
| | | | | | | | | carbonate | | | | | | |
| Example | / | / | / | / | / | / | / | Methyl | 20 | / | / | 20 | 75 | 83 |
| 2-12 | | | | | | | | trifluoroethyl | | | | | | |
| | | | | | | | | carbonate | | | | | | |
| Example | / | / | / | / | / | / | / | 2,2- | 20 | / | / | 20 | 76 | 85 |
| 2-13 | | | | | | | | difluoroethyl | | | | | | |
| | | | | | | | | acetate | | | | | | |
| Example | / | / | / | / | / | / | / | 2,2- | 10 | / | / | 10 | 73 | 79 |
| 2-14 | | | | | | | | difluoroethyl | | | | | | |
| | | | | | | | | acetate | | | | | | |
| Example | / | / | / | / | / | / | / | 2,2- | 30 | / | / | 30 | 77 | 83 |
| 2-15 | | | | | | | | difluoroethyl | | | | | | |
| | | | | | | | | acetate | | | | | | |
| Example | / | / | / | / | / | / | / | 2,2- | 50 | / | / | 50 | 75 | 84 |
| 2-16 | | | | | | | | difluoroethyl | | | | | | |
| | | | | | | | | acetate | | | | | | |
| Example | / | / | / | / | / | / | / | / | / | Ethyl | 20 | 20 | 78 | 86 |
| 2-17 | | | | | | | | | | acetate | | | | |
| Example | / | / | / | / | / | / | / | / | / | Ethyl | 20 | 20 | 77 | 85 |
| 2-18 | | | | | | | | | | propionate | | | | |
| Example | / | / | / | / | / | / | / | / | / | Propyl | 10 | 10 | 73 | 79 |
| 2-19 | | | | | | | | | | propionate | | | | |
| Example | / | / | / | / | / | / | / | / | / | Propyl | 20 | 20 | 76 | 82 |
| 2-20 | | | | | | | | | | propionate | | | | |
| Example | / | / | / | / | / | / | / | / | / | Propyl | 30 | 30 | 75 | 84 |
| 2-21 | | | | | | | | | | propionate | | | | |
| Example | / | / | / | / | / | / | / | / | / | Propyl | 50 | 50 | 77 | 83 |
| 2-22 | | | | | | | | | | propionate | | | | |
| Example | / | / | / | / | / | / | / | 2,2- | 5 | Propyl | 5 | 10 | 72 | 79 |
| 2-23 | | | | | | | | difluoroethyl | | propionate | | | | |
| | | | | | | | | acetate | | | | | | |
| Example | / | / | / | / | / | / | / | 2,2- | 10 | Propyl | 10 | 20 | 78 | 86 |
| 2-24 | | | | | | | | difluoroethyl | | propionate | | | | |
| | | | | | | | | acetate | | | | | | |
| Example | / | / | / | / | / | / | / | 2,2- | 15 | Propyl | 15 | 30 | 76 | 87 |
| 2-25 | | | | | | | | difluoroethyl | | propionate | | | | |
| | | | | | | | | acetate | | | | | | |
| Example | / | / | / | / | / | / | / | 2,2- | 30 | Propyl | 30 | 60 | 78 | 85 |
| 2-26 | | | | | | | | difluoroethyl | | propionate | | | | |
| | | | | | | | | acetate | | | | | | |
| Example | / | / | / | / | / | / | / | 2,2- | 35 | Propyl | 35 | 70 | 73 | 79 |
| 2-27 | | | | | | | | difluoroethyl | | propionate | | | | |
| | | | | | | | | acetate | | | | | | |
| Example | EC | 5 | FEC | 5 | 10 | 5 | 0.5 | 2,2- | 15 | Propyl | 15 | 30 | 80 | 91 |
| 2-28 | | | | | | | | difluoroethyl | | propionate | | | | |
| | | | | | | | | acetate | | | | | | |

In the above table, the mass percentage of each substance is based on the mass of the electrolyte, and “/” indicates that the substance is not included. Correspondence between the codes and compounds is as follows: EC is ethylene carbonate; PC is propylene carbonate; and FEC is fluoroethylene carbonate.

From Table 2, it can be learned that when the non-aqueous electrolyte of the lithium-ion battery prepared in the example of this application further includes a cyclic carbonate, and the mass percentage M % of the cyclic carbonate satisfies 5≤M≤30, the low-temperature discharge capacity retention rate of the lithium secondary battery can be further improved while the cycle capacity retention rate is improved. In particular, when at least one of 10≤M≤20 or 0.1≤B/M≤3 is satisfied, the effect of improving the low-temperature discharge capacity retention rate and cycle capacity retention rate of the lithium secondary battery is more significant. When the non-aqueous electrolyte of the lithium-ion battery prepared in the example of this application further includes a linear ester, and the mass percentage No % of the linear ester satisfies 10≤N₀≤70, the low-temperature discharge capacity retention rate of the lithium secondary battery can be further improved while the cycle capacity retention rate is improved. In particular, for the mass percentage N₁% of the fluorinated linear ester and the mass percentage N₂% of the non-fluorinated linear ester, when at least one of 5<N₁≤50, 5≤N₂≤50, or 20≤N₀≤60 is satisfied, the effect of improving the low-temperature discharge capacity retention rate and cycle capacity retention rate of the lithium secondary battery is more significant.

The lithium-ion batteries of Examples 3-1 to 3-19 are adjusted based on the parameters of Example 1-3. The lithium-ion battery of Example 3-20 is adjusted based on the parameters of Example 2-28. The specific adjustments are as follows. During the preparation of the electrolyte, specific types and amounts of polycyano compound, Formula II compound, and Formula III compound are added to the base solvent. The mass percentages of the substances in the electrolyte are as shown in Table 3. The performance test results of the lithium-ion batteries of the examples are shown in Table 3 below.

TABLE 3

| | | | | | | | | Low- | | High- |
|---|---|---|---|---|---|---|---|---|---|---|
| | | | Inner salt compound | | | | | temperature | | temperature |
| | | | | | | Formula | | discharge | Cycle | storage |
| | Polycyano compound | | | Formula | | III | Total | capacity | capacity | swelling |
| | | Amount | Formula | II amount | Formula | amount | amount | retention | retention | rate |
| Group | Type | X % | II type | (%) | III type | (%) | (%) | rate (%) | rate (%) | (%) |
| Example | / | / | / | / | / | / | / | 73 | 77 | 42 |
| 1-3 | | | | | | | | | | |
| Example | Succinonitrile | 2 | / | / | / | / | / | 75 | 80 | 24 |
| 3-1 | | | | | | | | | | |
| Example | Glutaronitrile | 2 | / | / | / | / | / | 76 | 81 | 25 |
| 3-2 | | | | | | | | | | |
| Example | 1,2- | 2 | / | / | / | / | / | 76 | 83 | 26 |
| 3-3 | bis(cyanoethoxy)ethane | | | | | | | | | |
| Example | Methyl glutaronitrile | 0.1 | / | / | / | / | / | 72 | 78 | 38 |
| 3-4 | | | | | | | | | | |
| Example | Methyl glutaronitrile | 0.5 | / | / | / | / | / | 76 | 80 | 32 |
| 3-5 | | | | | | | | | | |
| Example | Methyl glutaronitrile | 1 | / | / | / | / | / | 75 | 82 | 26 |
| 3-6 | | | | | | | | | | |
| Example | Methyl glutaronitrile | 2 | / | / | / | / | / | 77 | 85 | 21 |
| 3-7 | | | | | | | | | | |
| Example | Methyl glutaronitrile | 5 | / | / | / | / | / | 76 | 84 | 19 |
| 3-8 | | | | | | | | | | |
| Example | Methyl glutaronitrile | 10 | / | / | / | / | / | 74 | 79 | 35 |
| 3-9 | | | | | | | | | | |
| Example | / | / | II-1 | 0.15 | / | / | 0.15 | 75 | 81 | 34 |
| 3-10 | | | | | | | | | | |
| Example | / | / | / | / | III-1 | 0.15 | 0.15 | 75 | 80 | 33 |
| 3-11 | | | | | | | | | | |
| Example | / | / | II-1 | 0.15 | III-1 | 0.15 | 0.3 | 76 | 82 | 31 |
| 3-12 | | | | | | | | | | |
| Example | / | / | II-2 | 0.15 | III-2 | 0.15 | 0.3 | 78 | 85 | 32 |
| 3-13 | | | | | | | | | | |
| Example | / | / | II-3 | 0.15 | III-3 | 0.15 | 0.3 | 77 | 83 | 30 |
| 3-14 | | | | | | | | | | |
| Example | / | / | II-4 | 0.05 | III-4 | 0.05 | 0.1 | 72 | 78 | 37 |
| 3-15 | | | | | | | | | | |
| Example | / | / | II-4 | 0.1 | III-4 | 0.1 | 0.2 | 76 | 84 | 29 |
| 3-16 | | | | | | | | | | |
| Example | / | / | II-4 | 0.15 | III-4 | 0.15 | 0.3 | 75 | 83 | 27 |
| 3-17 | | | | | | | | | | |
| Example | / | / | II-4 | 0.25 | III-4 | 0.25 | 0.5 | 73 | 79 | 36 |
| 3-18 | | | | | | | | | | |
| Example | Methyl glutaronitrile | 2 | II-4 | 0.1 | III-4 | 0.1 | 0.2 | 79 | 86 | 19 |
| 3-19 | | | | | | | | | | |
| Example | Methyl glutaronitrile | 2 | II-4 | 0.1 | III-4 | 0.1 | 0.2 | 82 | 95 | 17 |
| 3-20 | | | | | | | | | | |

In the above table, the mass percentage of each substance is based on the mass of the electrolyte, and “/” indicates that the substance is not included.

From Table 3, it can be learned that when the non-aqueous electrolyte of the lithium-ion battery prepared in the example of this application further includes a polycyano compound, and the mass percentage X % of the polycyano compound satisfies 0.5≤X≤5, the high-temperature storage swelling rate of the lithium secondary battery can be lowered while the low-temperature discharge capacity retention rate and cycle capacity retention rate are improved. When the non-aqueous electrolyte of the lithium-ion battery prepared in the example of this application further includes an inner salt compound, and the mass percentage Y % of the inner salt compound satisfies 0.1≤Y≤0.5, the high-temperature storage swelling rate of the lithium secondary battery can be lowered while the low-temperature discharge capacity retention rate and cycle capacity retention rate are improved.

The above descriptions are only preferred embodiments of this application and are not intended to limit this application. Any modifications, equivalent substitutions, and improvements made within the principles of this application shall be included within the protection scope of this application.

What is claimed is:

1. A non-aqueous electrolyte, wherein the non-aqueous electrolyte comprises vinylene carbonate and a compound of Formula I: 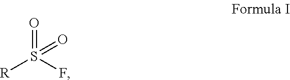
wherein R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, wherein the substituent Ra of each group is independently selected from fluorine or a C₁ to C₆ fluoroalkyl group;
based on a total mass of the non-aqueous electrolyte, a mass percentage of vinylene carbonate is A %, wherein 0.01≤A≤3; and a mass percentage of the compound of Formula I is B %; and
$$P = B / A , and 0.5 \leq P \underline{<} 50 .$$

2. The non-aqueous electrolyte according to claim 1, wherein the non-aqueous electrolyte satisfies at least one of the following conditions:
$$0.1 \leq A \leq 2 ; \qquad ( 1 )$$
$$0.5 \leq B \leq 5 ; or \qquad ( 2 )$$
$$1 \leq P \leq 5 . \qquad ( 3 )$$

3. The non-aqueous electrolyte according to claim 1, wherein the compound of Formula I is at least one selected from the following compounds:

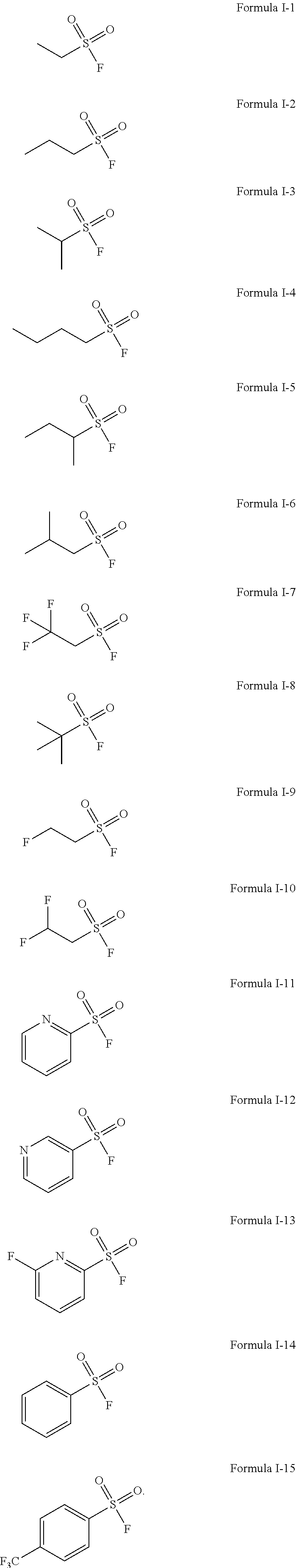

4. The non-aqueous electrolyte according to claim 1, wherein the non-aqueous electrolyte further comprises a cyclic carbonate; the cyclic carbonate includes any two selected from ethylene carbonate, propylene carbonate, or fluoroethylene carbonate; and
based on the total mass of the non-aqueous electrolyte, a mass percentage of the cyclic carbonate is M %, wherein 5≤M≤30.

5. The non-aqueous electrolyte according to claim 4, wherein 10≤M≤20; and/or 0.1≤B/M≤3.

6. The non-aqueous electrolyte according to claim 1, wherein the non-aqueous electrolyte further comprises a linear ester; the linear ester comprises a fluorinated linear ester and a non-fluorinated linear ester; and the linear ester satisfies at least one of the following conditions:
(1) the fluorinated linear ester is at least one selected from methyl difluoroethyl carbonate, methyl trifluoroethyl carbonate, ethyl trifluoroethyl carbonate, methyl hexafluoroisopropyl carbonate, di(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate;
(2) the non-fluorinated linear ester is at least one selected from dimethyl carbonate, methyl ethyl carbonate, methyl propyl carbonate, ethyl propyl carbonate, methyl acetate, ethyl acetate, propyl acetate, methyl propionate, ethyl propionate, or propyl propionate; or
(3) based on the total mass of the non-aqueous electrolyte, a mass percentage of the linear ester is No %, wherein 10≤N₀≤70.

7. The non-aqueous electrolyte according to claim 6, wherein based on the total mass of the non-aqueous electrolyte, the non-aqueous electrolyte satisfies at least one of the following conditions:
(1) a mass percentage of the fluorinated linear ester is N₁%, wherein 5≤N₁≤50;
(2) a mass percentage of the non-fluorinated linear ester is N₂%, wherein 5<N₂≤50; or
$$20 \leq {N}_{0} \leq 60 . \qquad ( 3 )$$

8. The non-aqueous electrolyte according to claim 1, wherein the non-aqueous electrolyte further comprises a polycyano compound; the polycyano compound is at least one selected from succinonitrile, glutaronitrile, methyl glutaronitrile, adiponitrile, pimelonitrile, suberonitrile, fumaronitrile, or 1,2-bis(cyanoethoxy) ethane; and
based on the total mass of the non-aqueous electrolyte, a mass percentage of the polycyano compound is X %, wherein 0.1≤X≤10.

9. The non-aqueous electrolyte according to claim 8, wherein 0.5≤X≤5.

10. The non-aqueous electrolyte according to claim 1, wherein the non-aqueous electrolyte further comprises a compound of Formula II and/or a compound of Formula III: 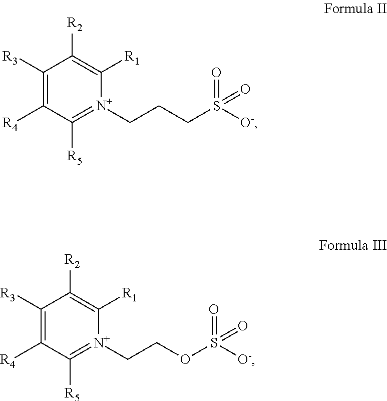
wherein R₁ to R₅ are independently selected from a hydrogen atom, a fluorine atom, a vinyl group, an ethynyl group, or an anhydride group;
based on the total mass of the non-aqueous electrolyte, a mass percentage of the compound of Formula II is Y₁%, a mass percentage of the compound of Formula III is Y₂%, and Y %=Y₁%+Y₂%, wherein 0.1≤Y≤0.5; and
any two adjacent groups among R₁ to R₅ either exist independently or are connected via a covalent bond, forming a ring with a parent ring.

11. The non-aqueous electrolyte according to claim 10, wherein the compound of Formula II is at least one selected from the following compounds: 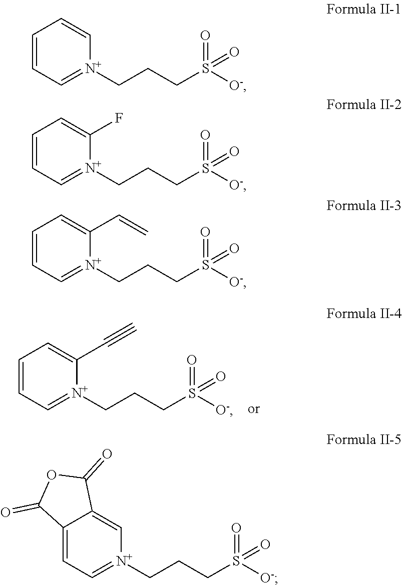
and/or the compound of Formula III is at least one selected from the following compounds:

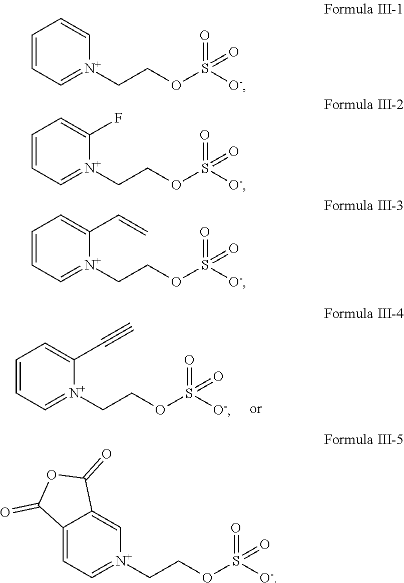

12. A lithium secondary battery, comprising:
a positive electrode, wherein the positive electrode comprises a positive electrode current collector and a positive electrode active layer disposed on at least one surface of the positive electrode current collector;
a negative electrode, wherein the negative electrode comprises a negative electrode current collector and a negative electrode active layer disposed on at least one surface of the negative electrode current collector;
a separator; and
a non-aqueous electrolyte, wherein the non-aqueous electrolyte comprises vinylene carbonate and a compound of Formula I: 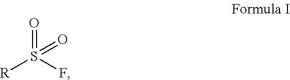
wherein R is selected from an unsubstituted or Ra-substituted C₂ to C₆ alkyl group, an unsubstituted or Ra-substituted C₂ to C₆ alkenyl group, an unsubstituted or Ra-substituted C₂ to C₆ alkynyl group, an unsubstituted or Ra-substituted C₅ to C₁₂ nitrogen-containing heteroaryl group, or an unsubstituted or Ra-substituted C₆ to C₁₂ aryl group, wherein the substituent Ra of each group is independently selected from fluorine or a C₁ to C₆ fluoroalkyl group;
based on a total mass of the non-aqueous electrolyte, a mass percentage of vinylene carbonate is A %, wherein 0.01≤A≤3; and a mass percentage of the compound of Formula I is B %; and
$$P = B / A , and 0.5 \leq P \underline{<} 50 .$$

13. The lithium secondary battery according to claim 12, wherein the non-aqueous electrolyte satisfies at least one of the following conditions:
$$0.1 \leq A \leq 2 ; \qquad ( 1 )$$
$$0.5 \leq B \leq 5 ; or \qquad ( 2 )$$
$$1 \leq P \leq 5 . \qquad ( 3 )$$

14. The lithium secondary battery according to claim 12, wherein the compound of Formula I is at least one selected from the following compounds:

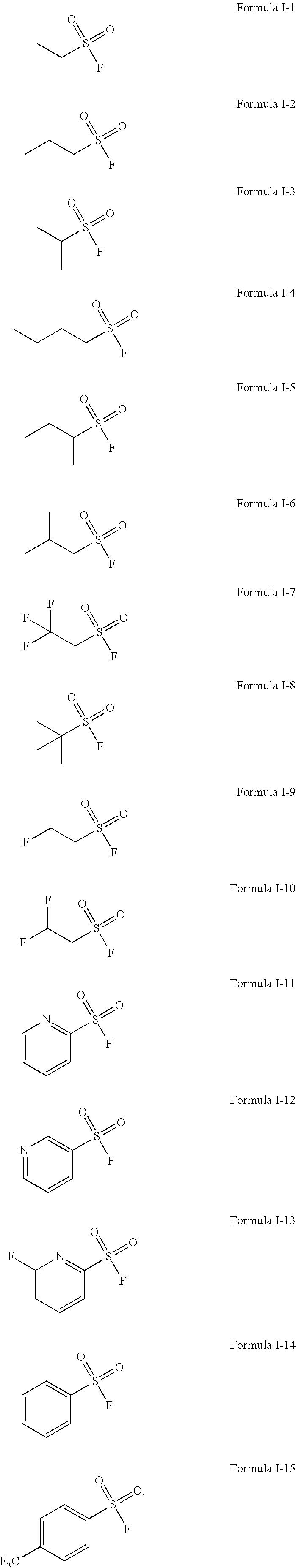

15. The lithium secondary battery according to claim 12, wherein the non-aqueous electrolyte further comprises a cyclic carbonate, the cyclic carbonate includes any two selected from ethylene carbonate, propylene carbonate, or fluoroethylene carbonate; and
based on the total mass of the non-aqueous electrolyte, a mass percentage of the cyclic carbonate is M %, wherein 5≤M≤30.

16. The lithium secondary battery according to claim 15, wherein 10≤M≤20; and/or 0.1≤B/M≤3.

17. The lithium secondary battery according to claim 12, wherein the non-aqueous electrolyte further comprises a linear ester; the linear ester comprises a fluorinated linear ester and a non-fluorinated linear ester; and the linear ester satisfies at least one of the following conditions:
(1) the fluorinated linear ester is at least one selected from methyl difluoroethyl carbonate, methyl trifluoroethyl carbonate, ethyl trifluoroethyl carbonate, methyl hexafluoroisopropyl carbonate, di(2,2,2-trifluoroethyl) carbonate, 2,2-difluoroethyl acetate, 2,2,2-trifluoroethyl acetate, hexafluoroisopropyl acetate, 2,2-difluoroethyl propionate, 2,2,2-trifluoroethyl propionate, or hexafluoroisopropyl propionate;
(2) the non-fluorinated linear ester is at least one selected from dimethyl carbonate, methyl ethyl carbonate, methyl propyl carbonate, ethyl propyl carbonate, methyl acetate, ethyl acetate, propyl acetate, methyl propionate, ethyl propionate, or propyl propionate; or
(3) based on the total mass of the non-aqueous electrolyte, a mass percentage of the linear ester is No %, wherein 10≤N₀≤70.

18. The lithium secondary battery according to claim 17, wherein based on the total mass of the non-aqueous electrolyte, the non-aqueous electrolyte satisfies at least one of the following conditions:
(1) a mass percentage of the fluorinated linear ester is N₁%, wherein 5≤N₁≤50;
(2) a mass percentage of the non-fluorinated linear ester is N₂%, wherein 5≤N₂≤50; or
$$20 \leq {N}_{0} \leq 60 . \qquad ( 3 )$$

19. The lithium secondary battery according to claim 12, wherein the non-aqueous electrolyte further comprises a polycyano compound, the polycyano compound is at least one selected from succinonitrile, glutaronitrile, methyl glutaronitrile, adiponitrile, pimelonitrile, suberonitrile, fumaronitrile, or 1,2-bis(cyanoethoxy) ethane; and
based on the total mass of the non-aqueous electrolyte, a mass percentage of the polycyano compound is X %, wherein 0.1≤X≤10.

20. The lithium secondary battery according to claim 19, wherein 0.5≤X≤5.
